(19) United States
(12) Patent Application Publication
(10) Pub. No.: US 2023/0040455 A1
(43) Pub. Date: Feb. 9, 2023

(54) CATALYST FOR USE IN BINDER COMPOSITIONS

(71) Applicant: Momentive Performance Materials Inc., Waterford, NY (US)

(72) Inventors: Jason H. STENGEL, Marietta, OH (US); Brandon B. DOSS, Parkersburg, WV (US)

(21) Appl. No.: 17/908,023

(22) PCT Filed: Mar. 1, 2021
(86) PCT No.: PCT/US2021/020235

§ 371 Date: Aug. 30, 2022

Related U.S. Application Data
(60) Provisional application No. 62/984,463, filed on Mar. 3, 2020.

(51) Int. Cl. C08G 18/64; C08G 18/22; C08G 18/76

(52) U.S. Cl. CPC C08G 18/6492; C08G 18/222; C08G 18/7664

(57) ABSTRACT

A catalyst composition, binder composition, and method for producing a cellulosic material is shown and described herein. In embodiments, the catalyst composition comprises (i) a metal elected from a metal complex comprising a metal from Groups IB, IIB, IVB, VB, VIIB, VIIB, and VIIIB of the Periodic Table of the Elements; and (ii) a solvent selected from a dialkyl sulfoxide, an organic carbonate; acetic acid; a carboxylic acid, an N-alkyl amides, organic carboxylic acid diester or diamide or mixed ester-amide, or a combinations of two or more thereof.

### CROSS-REFERENCE TO RELATED APPLICATIONS

This application claims priority to and the benefit of U.S. Provisional Patent Application 62/984,463 entitled “CATALYST FOR USE IN BINDER COMPOSITIONS,” filed on Mar. 3, 2020, the disclosure of which is incorporated herein by reference in its entirety.

### FIELD OF INVENTION

The present invention relates to a composition for use in cellulosic composite materials. In particular, the present invention relates to a catalyst composition suitable for use in cellulosic composite materials. The catalyst composition comprises a metal catalyst in a solvent. The catalyst compositions exhibit latent activity in isocyanates without significant loss of reactivity or viscosity build of the cellulosic composite system.

### BACKGROUND

Polyphenylene polymethylene polyisocyanate (pMDI) has been widely used as a binder in the commercial production of cellulosic based wood composites such as lignocellulosic composite panels. PMDI provides various physical and mechanical properties to the cellulose material and enhances the processability (e.g., production times) of such composites. Improved processability includes, for example, shorter pressing cycle times which result in increased production of the end product.

Lignocellulosic composite panels may be manufactured by introducing a binder, such as pMDI, into a rotary blender that contains lignocellulosic particles. After the binder and the particles have been mixed, the mixture can be introduced into a mold or a press where it is subjected to heat and pressure (e.g., pressing process) to form the composite panel. One drawback with the pressing process, however, is that long pressing times are typically required to cure the binder. While the composite panel manufacturer can increase the cure rate of the binder by using urethane catalysts known in the art, one drawback with the use of such catalysts is that additional binder must be used to compensate for the binder that is inactivated, due to pre-cure of the binder, prior to subjecting the mixture of binder and particles to a pressing process. In these instances, the manufacture typically suffers additional costs associated with using more binder than what was anticipated.

Pre-cure of the binder is also a concern in cases where a mixture of lignocellulosic particles and binder are not subjected to a pressing process in a timely manner. Typically, the cause of such delays is due to mechanical problems in the processing equipment.

Current catalyst options include amine catalysts such as dimorpholinodiethylether (DMDEE) or binder compositions employing an isocyanate in combination with a metal catalyst and an acidifying compound (e.g., U.S. Pat. No. 8,691,005). These solutions may also require higher use levels, be activated at inopportune times during the process, and/or require higher press temperatures and press times. Stability in the isocyanate as well as minimal to no premature reactivity is necessary to prevent trimerization of the isocyanate and viscosity build that might lead to curing too early in the process. In the wood binding process, cellulosic material is dried by heating, hot material is mixed with resin (pMDI or other resin such as, for example, phenol/formaldehyde/urea resin), the cellulosic material is oriented as needed, and then the cellulosic material is formed in a press under high temperature and pressure. The material often sticks to the upper and lower unit of the press due to cure timing and the release material may be inadvertently removed as the temperatures are regularly high during the pressing process.

The present technology attempts to address one or more of these issues.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

The present technology provides a catalyst composition, a binder or additive package comprising the catalyst composition, a cellulosic composition comprising the catalyst and/or the binder, and cellulosic materials formed from such compositions. The present catalysts remain stable in isocyanate below 80° C. for extended periods of time without significant loss in reactivity or viscosity build of the system. This allows for mixing of catalyzed resin with hot cellulosic materials for extended periods of time without initiating the reaction until needed. The catalysts may also allow for lower press temperatures, which can provide cost benefits to the process including lower energy consumption.

In one aspect, provided is a catalyst composition comprising (i) a metal elected from a metal complex comprising a metal from Groups IB, IIB, IVB, VB, VIB, VIIB, and VIIIB of the Periodic Table of the Elements; and (ii) a solvent selected from a dialkyl sulfoxide, an organic carbonate; a carboxylic; an N-alkyl amides, or a combinations of two or more thereof.

In another aspect, provided is a binder comprising the catalyst and an isocyanate.

In still another aspect, provided is a composition for forming a cellulosic composite comprising a cellulosic material, the present catalysts, and an isocyanate. In one embodiment, the catalyst and the isocyanate can be provided separately. In another embodiment, the catalyst and the isocyanate can be provided as part of a binder composition.

In still yet another aspect, provided is a method of forming a cellulosic composite material comprising forming a mixture of a cellulosic material, a catalyst, and an isocyanate and subjecting the mixture to heat and pressure to form a composite. In one embodiment, the catalyst and the isocyanate can be provided separately. In another embodiment, the catalyst and the isocyanate can be provided as part of a binder composition.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is a viscosity profile of different catalysts in a polyol and isocyanate;

FIG. 2 is an exotherm profile of the catalysts in FIG. 1;

FIG. 3 is a viscosity profile of Catalyst 1;

FIG. 4 is a viscosity profile of various catalyst compositions comparing reactivity of the title catalyst to tin-based catalysts in a formulation similar to that used in FIG. 1; and

FIG. 5 is an exotherm profile of the catalysts in FIG. 4;

### DETAILED DESCRIPTION

Reference will now be made to exemplary embodiments, examples of which are illustrated in the accompanying drawings. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a catalyst composition, a binder or additive package comprising the catalyst composition, a cellulosic composition comprising the catalyst/binder, and cellulosic materials formed from such compositions. The present catalysts are stable in isocyanates for extended periods of time without significant loss in reactivity or viscosity build in the system. The latent activity can allow for mixing catalyzed resin with hot cellulosic material for extended periods of time without initiating the reaction until desired (i.e., at slightly higher temperatures under pressure).

The catalyst comprises a catalyst composition comprising a metal catalyst material in a solvent. The metal catalyst material comprises a metal and a ligand or counter ion. The metal can be selected from a metal from Groups IB, IIB, IVB, VB, VIB, VIIB, and/or VIIIB of the Periodic Table of the Elements. Examples of suitable metals include, but are not limited to, Cu(II), Ni(II), Fe(II), Fe(III), Fe(IV), Zn, Zr, Mn, Cr, Ti, V, Mo, Ru, Rh, Bi, Sn, or a combination of two or more thereof. In one embodiment, the metal is Cu(II).

The ligand or counter ion may be chosen from a carboxylate, a diketonate, an organic salt, a halide, sulfonate, or a combination of two or more thereof. Suitable carboxylates include, but are not limited to, salicylates, salicylic acid, subsalicylate, lactate, citrate, subcitrate, ascorbate, acetate, dipropylacetate, tartrate, sodium tartrate, gluconate, subgallate, benzoate, laurate, myristate, palmitate, propionate, stearate, undecylenate, aspirinate, neodecanoate, ricinoleate, etc. Examples of diketonates include, but are not limited to, acetylacetonate. Examples of suitable halides include bromide, chloride, and iodide. Examples of suitable sulfonates include mesylate, triflate, esilate, tosylate, besylate, closylate, camsilate, pipsylate, and nosylate. In one embodiment, the catalyst comprises cupric acetylacetonate (Cu(II)(acac)₂). According to the present invention the terms copper salt, copper(II)salt or Cu(II) salt also include any forms of solvates, in particular, hydrates of such copper(II)-salts. The copper salts may be in particular in the form of hydrates. In one embodiment, the catalyst comprises copper (II) acetate hydrate. In another embodiment the catalyst compromises copper (II) acetate monohydrate. Further embodiments include anhydrous complexes of copper (II) acetate.

In one embodiment, the metal is a copper catalyst comprising a complex or salt of bivalent copper. Other suitable catalysts that can be used include, without limitation, organotin compounds, such as dialkyltindicarboxylates (e.g., dimethyltin dilaurate, dibutyltin dilaurate, dibutyltin di-2-ethyl hexanoate, dibutyltin diacetate, dioctyltin dilaurate, dibutyltin maleate, dibutyltin diisooctylmaleate); stannous salts of carboxylic acids (e.g., stannous octoate, stannous diacetate, stannous dioleate); mono- and diorganotin mercaptides (e.g., dibutyltin dimercaptide, dioctyltin dimercaptide, dibutyltin diisooctylmercaptoacetate); diorganotin derivates of beta-diletones (e.g., dibutyltin bis-acetylacetonate); diorganotin oxides (e.g., dibutyltin oxide); and mono- or diorganotin halides (e.d., dimethyltin dichloride and dibutyltin dichloride). Other suitable catalysts that can be used include, without limitation, organobismuth compounds, such as bismuth carboxylates (e.g., bismuth tris(2-ethlhexoate), bismuth neodecanoate, and bismuth naphtenate).

The catalyst composition comprises a solvent. Examples of suitable solvents include, but are not limited to, dialkyl sulfoxides such as, but not limited to, dimethyl sulfoxide, diethyl sulfoxide, diisobutyl sulfoxide, sulfolane, etc.; organic carbonates such as, but not limited to, di-methyl-carbonate, ethylene-carbonate, propylene-carbonate, etc.; acetic acid; carboxylic acids such as, but not limited to, aliphatic carboxylic acids having 2-50 carbon atoms, etc.; dibasic esters such as, but not limit to, aliphatic alkyl diesters, aromatic diesters, dimethyl glutarate, 2-methyl dimethyl glutarate, etc.; N-alkyl esters such as, but not limited to, 5-(dimethylamino)-2-methyl-5-oxo-dimethylpentanoate, etc.; N-alkyl amides such as, but not limited to, N-methyl pyrrolidone (NMP), N-n-butylpyrrolidone, N-isobutylpyrrolidone, N-t-butylpyrrolidone, N-n-pentylpyrrolidone, N-(methyl-substituted butyl) pyrrolidone, ring-methyl-substituted N-propyl pyrrolidone, ring-methyl-substituted N-butyl pyrrolidone, N-(methoxypropyl) pyrrolidone, N-(methoxypropyl) pyrrolidone, 1,5-dimethyl-pyrrolidone, etc.; N-alkyl alcohols such as, but not limited to 2-[2-(dimethylamino)ethoxy] ethanol, 2-[2-(diethylamino)ethoxy] ethanol, 1-(2-hydroxyethyl) pyrrolidine, 1-Methyl-2-pyrrolidine ethanol, 2-dimethylaminoethanol, 2-diethylaminoethanol, etc, tertiary cyclic amines such as, but not limited to, 1,8-diazabicyclo[5.4.0]undec-7-ene, 1,5-diazabicyclo[4.3.0]non-5-ene, 1,4-diazabicyclo[2.2.2]octane, and isomers thereof; or combinations of two or more thereof.

The catalyst composition can also include a mixture of two or more solvents. In one embodiment, the catalyst composition comprises a dialkyl sulfoxide and acetic acid and/or a carboxylic acid. The dialkyl sulfoxide may be present in an amount of from about 0% to about 100%, from about 10% to about 90%, or from about 25% to about 75%, or from about 50% to about 75% based on the total amount of the solvent; and the acetic acid or carboxylic acid may be present in an amount of from about 0% to about 100%, from about 10% to about 90%, or from about 25% to about 75%, or 25% to 50% based on the total amount of the solvent. In one embodiment the dialkyl sulfoxide is chosen from dimethyl sulfoxide, and the other solvent is acetic acid.

In one embodiment, the catalyst composition comprises a dialkyl sulfoxide and a N-alkyl amide. The dialkyl sulfoxide may be present in an amount of from about 50% to about 100%, from about 60% to about 90%, or from about 70% to about 80% based on the total amount of the solvent; and the N-alkyl amide may be present in an amount of from about 0% to about 50%, from about 10% to about 40%, or from about 20% to about 30% based on the total amount of the solvent. In one embodiment the dialkyl sulfoxide is chosen from dimethyl sulfoxide, and the N-alkyl amide is N-methyl pyrrolidone.

In one embodiment, the catalyst composition comprises an organic carbonate and acetic acid and/or a carboxylic acid. The acetic acid or carboxylic acid may be present in an amount of from about 10% to about 30%, from about 15% to about 25%, or from about 20% to about 25% based on the total amount of the solvent; and the organic carbonate may be present in an amount of from about 70% to about 90%, from about 75% to about 85%, or from about 75% to about 80% based on the total amount of the solvent. In one embodiment the organic carbonate is chosen from propylene carbonate, and the other solvent is acetic acid.

In another embodiment the catalyst composition comprises an amino-alcohol (2-[2-(dimethylamino)ethoxy]ethanol) and/or amine and alcohol and organic carbonate. The amino-alcohol and/or amine and alcohol may be present in a combined amount of from about 0.1% to about 30%, from about 0.1% to about 5%, or from 0.1% to about 0.25% based on the total amount of the solvent; and the organic carbonate may be present from about 70% to about 99.9%, from about 95 to about 99.9%, or from about 99.75% to about 99.9% based on the total amount of the solvent.

In one embodiment, the catalyst composition comprises an organic carbonate, an amino alcohol, and a carboxylic acid. The organic carbonate may be present in an amount of from about 50% to about 100%, from about 75% to about 99%, or from about 90% to about 98% based on the total amount of the solvent; the amino alcohol may be present in an amount of from about 0% to about 30%, from about 15% to about 25%, or from about 1% to about 5% based on the total amount of the solvent and the acetic acid or carboxylic acid may be present in an amount of from about 0% to about 30%, from about 15% to about 25%, or from about 1% to about 5% based on the total amount of the solvent. In one embodiment the organic carbonate is chosen from propylene carbonate, the carboxylic acid is salicylic acid and the other solvent is 2-[2-(dimethylamino)ethoxy]ethanol.

The catalyst composition may optionally comprise a co-diluent. The co-diluent may be chosen from a fatty acid, a vegetable oil, or a combination thereof. Examples of suitable vegetable oils include, but are not limited to, sunflower oil, safflower oil, castor oil, rapeseed oil, corn oil, Balsam Peru oil, soybean oil, etc. Suitable fatty acids include, but are not limited to, C₈ to C₂₂ mono- and dicarboxylic fatty acids. Other suitable co-diluents include, but are not limited to, polyether polyols, polyether diols such as PEG-400 and PPG-425, and propylene carbonate.

It will be appreciated, that the catalyst composition may comprise a mixture of two or more metal salts or complexes. The catalyst may comprise complexes/salts of different metals or may comprise different complexes having the same metal but a different ligand or counter ion. In one embodiment, a catalyst composition may be provided with a first Cu(II) salt dissolved in the solvent system. A second Cu(II) salt may be added to the composition comprising the first Cu(II) salt. In embodiments, the catalyst composition comprises Cu(II) acetylacetonate and Cu(II) acetate. Other combinations of metal salts may be chosen as desired for a particular purpose or intended application.

The metal complex may be added to and dissolved in the solvent, and the resulting catalyst solution may be filtered to clarity and stored under nitrogen at room temperature.

The catalyst composition may comprise the metal complex or salt in an amount of from about 0.04 wt % to about 10 wt %; from about 0.1 to about 7 wt % from about 0.5 to about 5 wt %; or from about 1 to about 2.5 wt %, with the balance of the catalyst composition comprising the solvent or solvent mixture. Here as elsewhere in the specification and claims, numerical values may be combined to form new and non-disclosed ranges. The balance of the catalyst composition may comprise the solvent and/or co-diluent.

The catalyst may be used separately or it may be provided as part of a binder composition. The binder composition, which may also be referred to as an additive package, may include (i) an isocyanate compound, and (ii) the metal catalyst composition.

Various isocyanate compounds may be used as component (i) in the binder composition of the present invention. For example, in certain embodiments, an isocyanate compound such as methylene diphenyl diisocyanate (“MDI”) can be used as component (i) in the binder composition. Suitable examples of MDI include those available under the RUBINATE® series of MDI products (available from Huntsman International LLC), those available under the Papi™ and Voranate™ series of MDI products (available from Dow Chemical), those available under the Lupranate® series of MDI products (available from BASF Corporation), and those available under the Mondur® series of MDI products (available from Covestro AG). It is well known in the art that many isocyanates of such MDI series can comprise polymeric MDI. Polymeric MDI is a liquid mixture of several diphenylmethane diisocyanate isomers and higher functionality polymethylene polyphenyl isocyanates of functionality greater than 2. These isocyanate mixtures usually contain about half, by weight, of the higher functionality species. The remaining diisocyanate species present in polymeric MDI are typically dominated by the 4,4′-MDI isomer, with lesser amounts of the 2,4′ isomer and traces of the 2,2′ isomer. Polymeric MDI is the phosgenation product of a complex mixture of aniline-formaldehyde condensates. It typically contains between 30 and 34% by weight of isocyanate (—NCO) groups and has a number averaged isocyanate group functionality of from 2.6 to 3.0.

In addition to the aforementioned isocyanate compounds, other suitable isocyanate compounds that can be used in the present invention include, but are not limited to aliphatic, aryl-aliphatic, araliphatic, aromatic, heterocyclic polyisocyanates, or a combination of two or more thereof having number averaged isocyanate (—NCO) group functionalities of 2 or greater and organically bound isocyanate group concentrations of from about 1% by weight to about 60% by weight. The range of polyisocyanates that may be used include prepolymers, pseudoprepolymers, and other modified variants of monomeric polyisocyanates known in the art that contain free reactive organic isocyanate groups. In certain embodiments, the isocyanate compound is liquid at 25° C.; has a viscosity at 25° C. of less than 10,000 cps, such as 5000 cps; and has a concentration of free organically bound isocyanate groups ranging from 10% to 33.6% by weight. In certain embodiments, an MDI series of isocyanates that is essentially free of prepolymers can be used as the isocyanate component. In these embodiments, the isocyanates comprise less than 1% by weight (e.g., less than 0.1% by weight or, alternatively, 0% by weight) of prepolymerized species. Members of these MDI series comprise can have a concentration of free organically bound isocyanate groups ranging from 31% to 32% by weight, a number averaged isocyanate (NCO) group functionality ranging from 2.6 to 2.9, and a viscosity at 25° C. of less than 1000 cps.

In one embodiment, the catalyst can be provided as part of a binder/additive package, i.e., a mixture of the isocyanate and the catalyst. In embodiments, the binder/additive package can comprise the catalyst in amount of from about 0.1 to 40 wt. %, from about 0.5 to about 30 wt. %, from about 1 to about 25 wt. % from about 2.5 to about 20 wt. %, or from about 5 to about 15 wt. %; and the isocyanate can be present in an amount of from about 60 to about 99.9 wt. %, from about 70 to about 99.5 wt. %, from about 75 to about 99 wt. %, from about 80 to about 97.5 wt. %, or from about 85 to about 95 wt %. In one embodiment, the catalyst is present in an amount of from about 0.1 to 10 wt. %, from about 0.5 to about 7 wt. % composition; or from about 1 to about 5 wt. %. In one embodiment, the additive package comprises the catalyst in an amount of from about 0.5 to about 1 wt. %; and the isocyanate is present in an amount of about 90 to 99.9 wt %, from about 93 to about 99.5 wt. % composition; or from about 95 to about 99 wt. %. In one embodiment, the additive package comprises the catalyst in an amount of from about 0.5 to about 1 wt. %

In certain embodiments, the isocyanate compound can comprise ≥90 weight % of the binder composition based on the total weight of the composition. In these embodiments, the remaining components (ii) and (iii) of the composition (combined), including the catalyst, comprise <10 weight % of the total weight of the composition.

The amount of metal catalyst (copper complex or salt) present in the binder composition may be from about 0.1 to about 10 wt %; from about 0.5 to about 7 wt %; from about 1 to about 5 wt % even from about 2 to about 4 wt % based on the weight of the isocyanate component.

The binder may include optional compounds or materials to impart particular properties to the binder and/or the cellulosic material. Suitable additives can include, but are not limited to, fire retardants, such as tris-(chloropropyl)phosphate (TCPP), triethyl phosphate (TEP), triaryl phosphates such as triphenyl phosphate, melamine, melamine resins, and graphite; pigments; dyes; antioxidants such as triaryl phosphites (e.g., triphenyl phosphite), and hindered phenols (e.g., butylated hydroxyl toluene (BHT), octadecyl-3-(3,5-di-tert-butyl-4-hydroxylphenol)propionate); light stabilizers; expanding agents; inorganic fillers; organic fillers (distinct from the lignocellulosic material described herein); smoke suppressants; slack waxes (liquid or low melting hydrocarbon waxes); antistatic agents; internal mold release agents, such as soaps, dispersed solid waxes, silicones, and fatty acids; inert liquid diluents, especially non-volatile diluents such as triglyceride oils (e.g., soy oil, linseed oil, and the like); biocides such as boric acid; or combinations of any of the forgoing.

As stated above, the present invention is also directed to a blended mixture or mass as well as a lignocellulosic composite. In certain embodiments, the blended mixture comprises the catalyst, isocyanate (provided separately or as part of a binder composition) and a lignocellulosic material. In certain embodiments, the lignocellulosic composite comprises the binder composition and a lignocellulosic material wherein both of these components have been combined and formed into the desired composite by using various methods known in the art.

The lignocellulosic materials that are used to form the blended mixture or the lignocellulosic composite can be selected from a wide variety of materials. For example, in some embodiments, the lignocellulosic material can be a mass of lignocellulosic particle materials. These particles can include, but are not limited to, wood chips or wood fibers or wood particles such as those used in the manufacture of orientated strand board (OSB), fiberboard, particleboard, carpet scrap, shredded non-metallic automotive wastes such as foam scrap and fabric scrap (sometimes referred to collectively as “light fluff”), particulate plastics wastes, inorganic or organic fibrous matter, agricultural by-products such as straw, baggasse, hemp, jute, waste paper products and paper pulp or combinations thereof.

The lignocellulosic composite can be formed by mixing the catalyst composition and isocyanate (separately or as part of a binder composition) with at least one lignocellulosic material. These materials are thoroughly mixed to form a blended mixture prior to the mixture being subjected to heat, pressure, or a combination thereof to form a lignocellulosic composite.

In certain embodiments, the binder composition is applied to the lignocellulosic materials, which is typically in the form of small chips, fibers, particles, or mixtures thereof, in a rotary blender or tumbler via one or more devices, such as spray nozzles or spinning disks, located in the blender. The lignocellulosic material is tumbled for an amount of time and sufficient to ensure adequate distribution of the binder composition over the lignocellulosic materials to form a blended mixture. Afterwards, the mixture is poured onto a screen or similar apparatus that approximates the shape of the final lignocellulosic composite. This stage of the process is called forming. During the forming stage the lignocellulosic materials are loosely packed and made ready for pressing. A constraining device, such as a forming box, is typically used in order to prevent the loose furnish for spilling out of the sides of the box. After the forming stage, the lignocellulosic materials are subjected to a pressing stage or pressing process where the lignocellulosic materials (including the binder composition) are subjected to elevated temperatures and pressure for a time period that is sufficient to cure the binder composition and form the desired lignocellulosic product. In certain embodiments, the pressing stage can be in the form of continuous or discontinuous presses. In some embodiments, the lignocellulosic materials are pressed at a temperature ranging from 148.0° C. to 232.2° C. (300° F.-450° F.) for a pressing time cycle ranging from 1.5 minutes to 10 minutes. After the pressing stage, the lignocellulosic product that is typically formed can have a thickness ranging from 0.25 cm to 7.62 cm (0.09 inches to 3.0 inches).

Once the binder or adhesive is applied onto the substrates, the substrates are moved into a press and compression molded at a press temperature and for a period of time (press residence time) sufficient to cure the binder composition and, optional, adhesive. The amount of pressure applied in the press is sufficient to achieve the desired thickness and shape of the final composite. Pressing may optionally be conducted at a series of different pressures (stages). The maximum pressure is typically between 200 psi and 800 psi but is more preferably from 300 psi and 700 psi. The total residence time in the press, for a typical OSB manufacturing process, is desirably between 6 seconds per millimeter panel thickness and 18 seconds per millimeter panel thickness, but more preferably between 8 seconds per millimeter panel thickness and 12 seconds per millimeter panel thickness. Pressing is typically accomplished with metal platens which apply pressure behind metal surface plates referred to as caul plates. The caul plates are the surfaces which come into direct contact with the adhesive treated furnish (board pre-forms) during pressing. The caul plates are typically carbon steel plates, but stainless-steel plates are sometimes used. The metal surfaces of the caul plates which come into contact with the adhesive-treated lignocellulosic substrate are desirably coated with at least one external mold release agent in order to provide for recovery of the product without damage. The use of external mold release is less important when the three-layer approach (e.g., phenol formaldehyde resin used on the two outer layers with an isocyanate-based adhesive used in the core layer) is used but is still desirable. Non-limiting examples of suitable external mold release agents include fatty acid salts such as potassium oleate soaps, or other low surface energy coatings, sprays, or layers.

After the pressing stage, the cured compression molded lignocellulosic composite is removed from the press and any remaining apparatus, such as forming screens and caul plates, is separated. Rough edges are typically trimmed from the lignocellulosic composite. The freshly pressed articles can then be subjected to conditioning for a specified time at a specified ambient temperature and relative humidity, in order to adjust the moisture content of the wood to a desired level. This conditioning step is optional however. While OSB is typically a flat board, the production of compression molded lignocellulosic articles with more complex three-dimensional shapes is also possible.

Though specific embodiments of the invention have been described with respect to OSB production, one skilled in the art could apply the present technology to production of other types of compression molded lignocellulosic products such as fiberboard, medium density fiberboard (MDF), particle board, straw board, rice hull board, laminated veneer lumber (LVL), and the like.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### EXAMPLES

Catalyst Compositions

Various catalyst compositions were prepared by mixing cupric acetyl acetonate (Cu(acac)₂) with a selected solvent. Generally, the material was solubilized at room temperature in the specified solvents. In the case of the acetic acid/PC solvent system, the Cu(II) complex was first dissolved in AcOH then diluted with the co-solvent, i.e. PC, DMSO, etc. Carbon treatment of the solvents may be necessary as well prior to the dissolution of the metal complex. Heating is not required but can slightly increase the concentration of the metal complex. This, however, results in discoloration and in the presence of air, redox chemistry occurs. The carbon treatment aids in solubility particularly for lower grade solvents.

TABLE 1
Catalyst Compositions

| Catalyst | Solvent | Metal |
|---|---|---|
| 1 | 100% DMSO | 0.076% Cu |
| 2 | 75% DMSO | 0.073% Cu |
| | 25% Acetic Acid | |
| 3 | 75% Propylene carbonate | 0.073% Cu |
| | 25% Acetic Acid | |
| 4 | 100% NMP | 0.057% Cu |
| 5 | 85% NMP | 0.057% Cu |
| | 15% DMSO | |
| 6 | 100% DMSO | 0.057% Cu |
| Comparative Catalyst 1 | 100% DMDEE | — |
| Comparative Catalyst 2 | 100% Dibutyltin dilaurate | ~17.5% |

### Examples 1-12/Comparative Examples 1 and 2

The viscosity and exotherm profiles of various catalysts are evaluated in a polyurethane test formulation. The test formulation includes 94 pphr of polyether polyol (OH=35); 6 pphr of ethylene glycol; 0.1-5 pphr of catalyst and 105 pphr of isocyanate (200 cPs MDI with 31% NCO, and an equivalent weight of 134). The catalysts compositions are as follows:

TABLE 2
Catalysts Employed in Viscosity/Exotherm Build Testing

| Example | Catalyst |
|---|---|
| 1 | 1 |
| 2 | 2 |
| 3 | 3 |
| 4 | 4 |
| 5 | 5 |
| 6 | 6 |
| C1 | Comparative Catalyst 1 |
| C2 | Comparative Catalyst 2 |
| 7 | 1 (2 pph) |
| 8 | 1 (5 pph) |
| 9 | 1 |
| 10 | 2 |
| 11 | 3 |
| 12 | 4 |

The reactions were run at ambient temperature with chemical temperatures starting at 20 to 35° C. at a catalyst use level of 10 parts per hundred (pph) relative to isocyanate (10 grams of catalyst to 100 grams of isocyanate). The isocyanate containing catalyst was mixed with a polyol (˜6000 g/mol, triol based polyol with OH value of ˜34 mg KOH/g) at an index of ˜105 for 10 seconds. At the end of ten seconds the PU resin was poured into a cup and analyzed via Brookfield viscometer and DASYLab® data acquisition software.

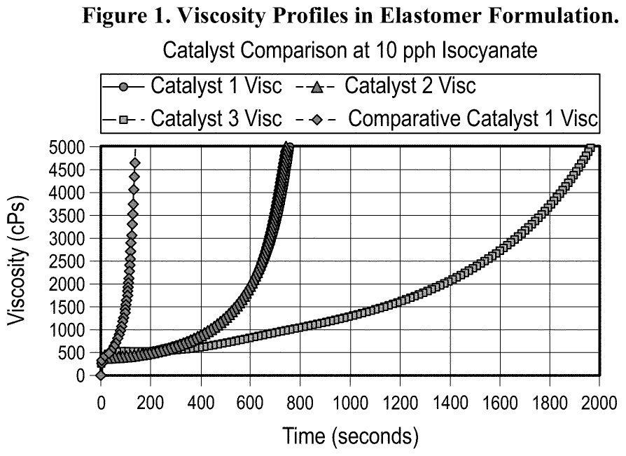

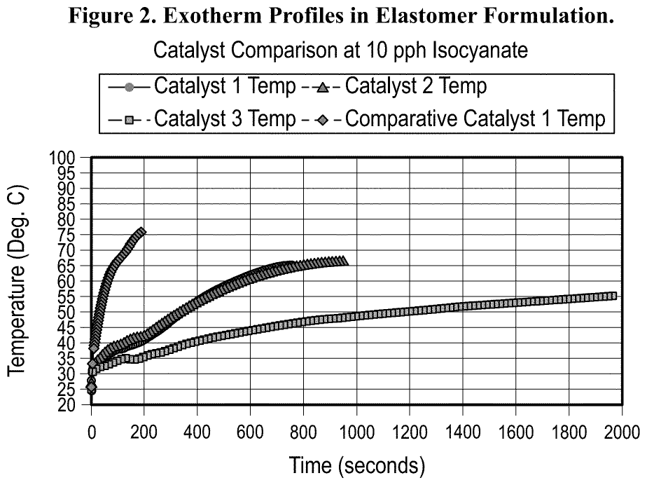

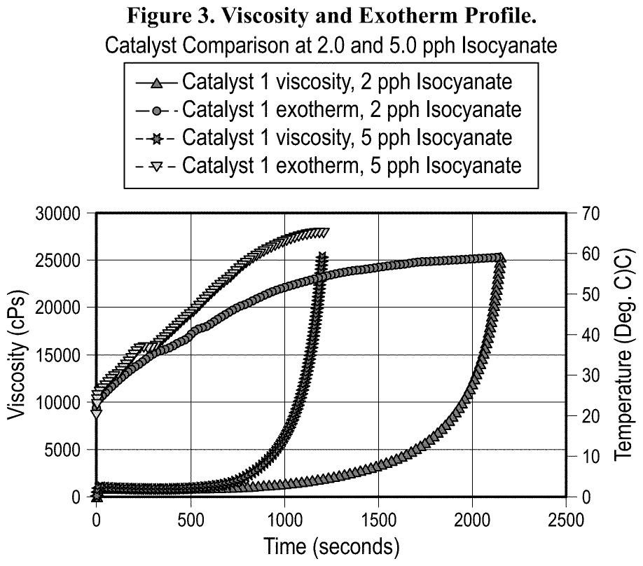

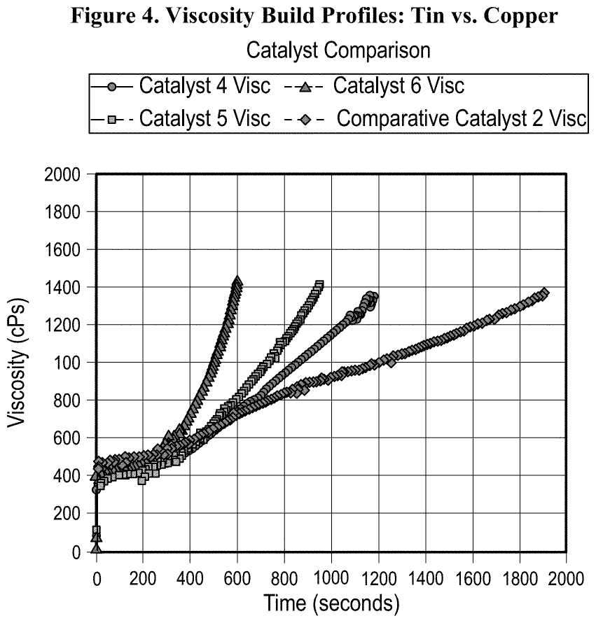

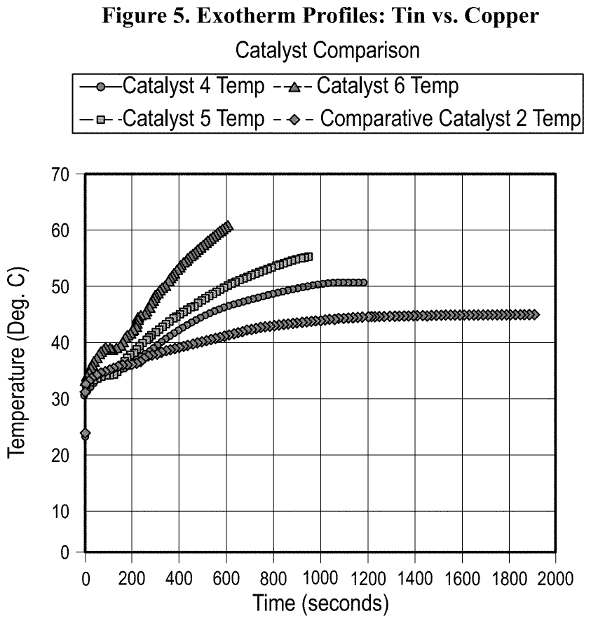

FIGS. 1 and 4 show viscosity profiles for the compositions with the different catalysts. FIGS. 2 and 5 show the exotherm profiles for the compositions and FIG. 3 shows both the viscosity build and exotherm profile for catalyst 1 at two different levels. As shown in FIGS. 1-5, the present catalysts exhibit longer viscosity build times and lower exotherm profiles compared to the comparative example using DMDEE. FIGS. 1-5 show that the conventional catalysts for this type of application (DMDEE and tin catalyst—DBTDL) are too fast under ambient conditions in the case of the DMDEE (FIGS. 1 and 2). The tin catalyst shows very slow reactivity (FIGS. 4 and 5) at ambient temperature, but this catalyst is known to have a low activation temperature and may result in premature activation at temperatures lower than that desired prior to the press process. It is likely that the binder resin would cure on the process line prior to arriving at the press and thus result in undesired maintenance. Tin catalysts typically lack the ability to efficiently facilitate the isocyanurate reaction or the water-iso reaction forming urea.

Viscosity and exotherm profiles of Catalyst 1 were evaluated at different catalyst loadings. Example 7 employs 2.0 pph of catalyst relative to the isocyanate charge in the elastomer formulation, and Example 8 employs 5.0 pph relative to the isocyanate charge in the elastomer formulation. The viscosity and exotherm profiles are shown in FIG. 3.

Aging Studies

Bench top and oven (accelerated) aging studies were conducted to confirm that Catalyst 1 was stable in isocyanate (200 cPs pMDI). The specific isocyanate used in these experiments was Papi™ 27 (available from Dow Chemical). These studies have been duplicated with other solvent/catalyst compositions to confirm stability in isocyanate.

### Examples 13-16—Viscosity Development Via Accelerated Aging

Viscosity development at elevated temperature was also determined for Catalyst 1. The formulated material (catalyst combined with isocyanate) was placed in an oven at 105° C. and the viscosity analyzed via Brookfield viscometer at 24 hour intervals.

TABLE 3
Accelerated aging of Catalyst 1 composition.

| | 5pphl | Neat 200 cPs | 200 cPs | 200 cPs |
|---|---|---|---|---|
| | Catalyst 1 in | Isocyanate- | Isocyanate-2pphl | Isocyanate- |
| Hours | 200 cPs | 105° C.-no | Catalyst 1- | 5pphl Catalyst |
| (days) | Isocyanate-RT | catalyst | 105° C. | 1-105° C. |
| 0 | 105 | 220 | 145 | 105 |
| 24 (1) | — | 262 | 424 | 787 |
| 48 (2) | — | 436 | 1126 | 5461 |
| 72 (3) | 117 | — | — | — |
| 108 | | — | — | — |
| 120 (5) | | 1503 | 16708 | >25000 |
| 144 (6) | | 1941 | 25129 | >>25000 |

The first column is data for the catalyst in 200 cPs isocyanate at room temperature. The second column is neat 200 cPs isocyanate at 105° C. The third column is data for 2 pphI Catalyst 1 in 200 cPs isocyanate. The fourth column is data for 5 pphI Catalyst 1 in 200 cPs isocyanate.

Previous studies indicated stability at 60° C., at high use levels, whereas at elevated temperature (above 80° C., activation temperature for catalyst 1) viscosity increase is noted. Storage conditions may be elevated and result in unwanted reactivity for higher loads of catalyst. Both 2 pphI (parts per hundred isocyanate) and 5 pphI are much greater than would be needed for catalyzing the binder reaction (MDI-cellulosic material reaction and urea formation via reaction of isocyanate with water). The nominal “activation” temperature for the catalyst complex is ˜80° C.

### Composite Panel Examples

Panels were produced using standard processing conditions consistent with the Oriented Strand Board (OSB) industry reduced to laboratory scale. Wood strands were obtained from Louisiana Pacific. All blends were prepared in a 5′×10′ blender; Atomizer speed 8,700 rpm; Cone #1 (2 rows of holes, 0.180″ diameter); Resin intro: 500 mL/min (5% loading), 300 mL/min (2.5% loading); Catalyst intro: 100 mL/min; Strands received moisture content at 5%, water was added (as part of the blending process) to increase moisture content to ˜8%; strands were oriented manually which results in less than perfect orientation when compared to the automated methods in industry. Isocyanate was charged to the strands at 5% based on the weight of the strands via spinning disc aspirator. Catalyst was charged via aspirator at a level of 0.5% to 1.0% based on the weight of the strands. The strands were at 70° F. (21.1° C.) during the blending process. Blends were hand stranded. The rough strands were placed in the press. The press was at a temperature of 415° F. for standard conditions and press time to form the composite was 180 seconds under standard conditions. The catalysts in Example 12—was Catalyst 1 or Catalyst 3. The control experiment was panel production without catalyst. DMDEE is used as a comparative example.

Target dimensions, specifications, and mechanical properties were adopted from European Panel Federation (EPF) sources and used only as guidance for general performance comparisons within the experimental panel groups. EPF classifications are:

OSB/1—General Purpose for use in dry conditions

OSB/2—Load bearing dry conditions

OSB/3—Load bearing humid conditions

OSB/4—Heavy-duty load bearing for use in humid conditions

EN 300 provides definitions, classifications, and specifications for OSB.

23/32″ thickness OSB panels were produced, dressed to 30″×30″, using a 5% pMDI load, 0.75% wax load, and Aspen wood strands at 8% moisture content. The strands were added to the blender followed by water, wax, pMDI, and catalyst. Target density for the boards was 36-38 pcf (576-608 Kg/m³).

Mechanical property targets were two-fold:

(1) Resin formulations utilizing Catalyst 1 or Catalyst 3 should provide boards/panels with comparable or improved physical properties to boards produced w/o the subject catalysts; and
(2) Boards produced using extreme processing conditions (low temperature, decreased time, and reduced pMDI loads) should provide comparable or improved physical properties when compared to boards produced under standard conditions without catalyst.

Five sets of experiments were conducted regarding the production process for OSB and one parameter for blending of the resin with strands.

Experiment #1—Standard conditions

Experiment #2—Decreased press time (˜10% reduction)

Experiment #3—Reduction in pMDI loading

Experiment #4—Reduction in press time and pMDI loading

Experiment #5—Reduction in press temperature

Experiment #6—two sets of boards were produced using an isocyanate/catalyst pre-blend—one using decreased press time only and a second looking at decreased press time with reduced pMDI levels. This experiment was conducted to confirm if the process of addition of catalyst would have any bearing on the physical properties as a result of catalyst-resin proximity.

General Comments on Experiments

Experiment #1: (Standard Conditions): under the standard conditions there were no noticeable issues during production. Catalyst 1 put off no odor during blending at ambient or at elevated temperature during pressing at 0.5% load. Catalyst 1 at 1.0% loading provided only a faint odor, nearly undetectable with still no odor in finished boards. Catalyst 3 has an acetic acid odor at ambient and elevated temperature but only slightly in the finished/dressed boards. Standard conditions for panel production are as follows; 415° F. press temperature with a press time of 180 seconds (20 seconds off gassing), 0.5% catalyst load if used, 0.75% wax loading, and 5% MDI load.

Experiment #2: Press time reduction of 40 seconds (22% reduction from 180 seconds, 140 second press time) using Catalyst 1 resulted in lower quality boards, 150 second press time provided slightly under-cured boards and the minimum time of 160 seconds provided acceptable panels and was chosen for as a minimum press time so that physical properties could be obtained.

Experiment #3—pMDI reduction did not negatively impact the processing, all boards were acceptable.

Experiment #4—press time and pMDI loading reduction resulted in acceptable panels at 160 second press time with 2.5% load of pMDI.

Experiment #5—Press temperature was reduced to 300° F. and increase by 25° F. until under-cure was not visible. At 350° F. boards were still under cured (with 180 second press time). 375° F. was determined to be the minimal temperature for acceptable panel production. The use of no catalyst at this temperature resulted in severely under cured boards, most noticeable on the edges and corners.

Experiment #6—variable introduction of catalyst to determine if mixing the catalyst with the isocyanate will improve panel quality

Water Absorption and Thickness Swelling

Water absorption and thickness swell of the composites is evaluated using ASTM D1037-12 under the different conditions (Experiments 1-6 described above). WA Vol is the % change in volume of the specimen (initial−final)/initial*100 and WA Wt. is % change in weight of the specimen.

Experiment #1: Standard Conditions

The subject catalysis provides minimal impact on water absorption and thickness swelling vs. no catalyst—comparing catalyzed (both catalyst 1 and catalyst 3) to un-catalyzed only.

TABLE 4
(Experiment - Standard Conditions)

| | | | | | | Water Absorption/Thickness Swell | | | | | |
|---|---|---|---|---|---|---|---|---|---|---|---|
| Platen | Press | | | | | Initial | Initial | | | TS | TS |
| Temp | Cook Time | | Catalyst | Catalyst/MDI | MDI | MC | Density | WA | WA | 1″ in | edge |
| (F.) | (sec) | Catalyst | Loading | Introduction | Loading | (%) | (pcf) | (Vol %) | (Wt %) | (%) | (%) |
| 415 | 180 | none | na | Separate | 5.0% | 4.7 | 39.9 | 7.0 | 21.1 | 6.4 | 16.1 |
| 415 | 180 | 1 | 0.5% | Separate | 5.0% | 4.3 | 38.4 | 5.9 | 20.0 | 5.4 | 14.6 |
| 415 | 180 | 2 | 0.5% | Separate | 5.0% | 4.1 | 38.2 | 5.7 | 19.4 | 5.2 | 14.9 |

Thickness swell (TS) values for EPF grades range from 12% (OSB/4) to 25% (OSB1) for reference only. Density variation noted in the specimens is not considered significant; however, the lower density board should absorb more water. Under standard processing parameters, there was no marked improvement in water absorption, thickness swell (TS 1″ in), or edge swell (TS edge) in the catalyzed system vs. non-catalyzed system. The density of the catalyzed specimens was slightly lower than the un-catalyzed specimens, thus the 1% improvement in TS and edge swell (ES) may indicate a slight improvement in board quality. Target values of less than 25% for OSB/1, <20% for OSB/2, <15% for OSB/3, and <12% for OSB/4 were obtained for both catalyzed systems and the un-catalyzed system. Edge swell and thickness swell were ˜1% higher for the un-catalyzed system.

Experiment #2/#6: Decreased Press Time and Catalyst Introduction Study

TABLE 5
(Decreased Press Time)

| | | | | | | Water Absorption/Thickness Swell | | | | | |
|---|---|---|---|---|---|---|---|---|---|---|---|
| Platen | Press | | | | | Initial | Initial | | | TS | TS |
| Temp | Cook Time | | Catalyst | Catalyst/MDI | MDI | MC | Density | WA | WA | 1″ in | edge |
| (F.) | (sec) | Catalyst | Loading | Introduction | Loading | (%) | (pcf) | (Vol %) | (Wt %) | (%) | (%) |
| 415 | 160 | none | na | Separate | 5.0% | 4.3 | 36.1 | 7.7 | 22.3 | 7.0 | 15.7 |
| 415 | 160 | Catalyst 1 | 0.5% | Separate | 5.0% | 4.3 | 36.3 | 6.7 | 21.5 | 6.1 | 15.1 |
| 415 | 160 | Catalyst 3 | 0.5% | Separate | 5.0% | 4.0 | 37.0 | 6.9 | 20.9 | 6.2 | 14.8 |
| 415 | 160 | Catalyst 1 | 0.5% | Pre-Mixed | 5.0% | 4.2 | 37.0 | 6.6 | 20.8 | 6.0 | 15.0 |
| 415 | 160 | Comparative | 0.5% | Separate | 5.0% | 4.3 | 36.6 | 23.1 | 42.7 | 21.9 | 33.8 |
| | | Catalyst 1 | | | | | | | | | |

Premix vs. separate addition of Catalyst 1 does not appear to have an impact on the WA/TS. Comparison of the set shows all being equal except for DMDEE which provided three times water absorption volume and two to three times TS. Catalyst 1 and Catalyst 3 provide minimal benefit over non-catalyzed system (0.5-1.0% improvement). WA and TS for the new catalysts using shorter press times of 160 secs was comparable to the WA/TS at standard conditions, indicating press time and the use of the subject catalysis does not negatively impact this property.

Experiment #3: Reduction in pMDI Loading

TABLE 6
(Decreased pMDI/Standard conditions)

| | | | | | | Water Absorption/Thickness Swell | | | | | |
|---|---|---|---|---|---|---|---|---|---|---|---|
| Platen | Press | | | | | Initial | Initial | | | TS | TS |
| Temp | Cook Time | | Catalyst | Catalyst/MDI | MDI | MC | Density | WA | WA | 1″ in | edge |
| (F.) | (sec) | Catalyst | Loading | Introduction | Loading | (%) | (pcf) | (Vol %) | (Wt %) | (%) | (%) |
| 415 | 180 | none | na | Separate | 2.5% | 4.4 | 37.3 | 9.2 | 26.4 | 8.6 | 20.3 |
| 415 | 180 | Catalyst 1 | 0.5% | Separate | 2.5% | 4.5 | 36.9 | 8.1 | 25.4 | 7.4 | 18.1 |
| 415 | 180 | Catalyst 3 | 0.5% | Separate | 2.5% | 4.2 | 37.6 | 9.4 | 26.3 | 8.8 | 20.1 |
| 415 | 180 | Comparative | 0.5% | Separate | 2.5% | 4.5 | 36.9 | 79.2 | 80.6 | 76.1 | 83.3 |
| | | Catalyst 1 | | | | | | | | | |

At 50% reduction of pMDI loading we see some improvement in WA/TS with the Catalyst 1 vs. Comparative Example 1 (without any catalyst). Catalyst 3 maintains similar performance to the control. Comparative catalyst 1 is substantially worse absorbing 3-4 times water resulting in an order of magnitude difference in TS swell at 1″ and 4 times TS edge vs. all others. Decreasing the MDI had a greater impact on the WA/TS than the press time with a 3-5% increase in edge TS and 1-2% increase at 1″ TS. TS at the edge is greater in all cases.

Experiment #4/#6: Reduction in Press Time, pMDI Loading, and Catalyst Introduction Study

TABLE 7
(Decreased pMDI and press; standard temp; higher catalyst load)

| | | | | | | Water Absorption/Thickness Swell | | | | | |
|---|---|---|---|---|---|---|---|---|---|---|---|
| Platen | Press | | | | | Initial | Initial | | | TS | TS |
| Temp | Cook Time | | Catalyst | Catalyst/MDI | MDI | MC | Density | WA | WA | 1″ in | edge |
| (F.) | (sec) | Catalyst | Loading | Introduction | Loading | (%) | (pcf) | (Vol %) | (Wt %) | (%) | (%) |
| 415 | 160 | Catalyst 1 | 1.0% | Separate | 2.5% | 4.6 | 35.9 | 9.9 | 30.0 | 9.2 | 18.9 |
| 415 | 160 | Catalyst 3 | 1.0% | Separate | 2.5% | 4.3 | 37.8 | 7.3 | 21.8 | 6.6 | 16.0 |
| 415 | 160 | Catalyst 1 | 1.0% | Pre-Mixed | 2.5% | 4.3 | 37.9 | 9.8 | 27.4 | 9.1 | 20.4 |

Both Catalyst 1 and Catalyst 3 provide WA/TS values comparable to the previous low-level MDI experiment. Pre-mix and separate addition of the catalyst were comparable as well indicating no impact on TS/WA. Increasing catalyst level to when using reduced pMDI levels and reduced press time allows for comparable performance to that of standard processing conditions with reduced pMDI levels. This indicates positive impact of the catalyst under these more extreme conditions and that pMDI levels are the critical parameter for WA/TS properties.

Experiment #5: Reduction in Press Temperature

TABLE 8
(reduced temp)

| | | | | | | Water Absorption/Thickness Swell | | | | | |
|---|---|---|---|---|---|---|---|---|---|---|---|
| Platen | Press | | | | | Initial | Initial | | | TS | TS |
| Temp | Cook Time | | Catalyst | Catalyst/MDI | MDI | MC | Density | WA | WA | 1″ in | edge |
| (F.) | (sec) | Catalyst | Loading | Introduction | Loading | (%) | (pcf) | (Vol %) | (Wt %) | (%) | (%) |
| 385 | 180 | Catalyst 1 | 0.5% | Separate | 5.0% | 4.3 | 37.8 | 7.3 | 21.8 | 6.6 | 16.0 |
| 375 | 180 | none | na | Separate | 5.0% | 4.8 | 36.3 | 8.6 | 23.0 | 8.0 | 16.3 |
| 375 | 180 | Catalyst 1 | 0.5% | Separate | 5.0% | 4.7 | 34.8 | 7.4 | 25.1 | 6.7 | 15.2 |

Catalyst 1 performed at the lowest temperature where no catalyst did not provide an acceptable board. Acceptable boards with no catalyst were obtained at 375° F. Water absorption and TS were comparable for Catalyst 1 vs. no-catalysis.

### GENERAL SUMMARY AND CONCLUSION

TABLE 9
(summary including low press time data)

| | | | | | | Water Absorption/Thickness Swell | | | | | |
|---|---|---|---|---|---|---|---|---|---|---|---|
| Platen | Press | | | | | Initial | Initial | | | TS | TS |
| Temp | Cook Time | | Catalyst | Catalyst/MDI | MDI | MC | Density | WA | WA | 1″ in | edge |
| (F.) | (sec) | Catalyst | Loading | Introduction | Loading | (%) | (pcf) | (Vol %) | (Wt %) | (%) | (%) |
| 415 | 180 | none | na | Separate | 5.0% | 4.7 | 39.9 | 7.0 | 21.1 | 6.4 | 16.1 |
| 415 | 180 | Catalyst 1 | 0.5% | Separate | 5.0% | 4.3 | 38.4 | 5.9 | 20.0 | 5.4 | 14.6 |
| 415 | 180 | Catalyst 3 | 0.5% | Separate | 5.0% | 4.1 | 38.2 | 5.7 | 19.4 | 5.2 | 14.9 |
| 415 | 160 | none | na | Separate | 5.0% | 4.3 | 36.1 | 7.7 | 22.3 | 7.0 | 15.7 |
| 415 | 160 | Catalyst 1 | 0.5% | Separate | 5.0% | 4.3 | 36.3 | 6.7 | 21.5 | 6.1 | 15.1 |
| 415 | 160 | Catalyst 3 | 0.5% | Separate | 5.0% | 4.0 | 37.0 | 6.9 | 20.9 | 6.2 | 14.8 |
| 415 | 160 | Catalyst 1 | 0.5% | Pre-Mixed | 5.0% | 4.2 | 37.0 | 6.6 | 20.8 | 6.0 | 15.0 |
| 415 | 160 | Comparative | 0.5% | Separate | 5.0% | 4.3 | 36.6 | 23.1 | 42.7 | 21.9 | 33.8 |
| | | Catalyst 1 | | | | | | | | | |
| 415 | 180 | none | na | Separate | 2.5% | 4.4 | 37.3 | 9.2 | 26.4 | 8.6 | 20.3 |
| 415 | 180 | Catalyst 1 | 0.5% | Separate | 2.5% | 4.5 | 36.9 | 8.1 | 25.4 | 7.4 | 18.1 |
| 415 | 180 | Catalyst 3 | 0.5% | Separate | 2.5% | 4.2 | 37.6 | 9.4 | 26.3 | 8.8 | 20.1 |
| 415 | 180 | Comparative | 0.5% | Separate | 2.5% | 4.5 | 36.9 | 79.2 | 80.6 | 76.1 | 83.3 |
| | | Catalyst 1 | | | | | | | | | |
| 415 | 160 | Catalyst 1 | 1.0% | Separate | 2.5% | 4.6 | 35.9 | 9.9 | 30.0 | 9.2 | 18.9 |
| 415 | 160 | Catalyst 3 | 1.0% | Separate | 2.5% | 4.3 | 37.8 | 7.3 | 21.8 | 6.6 | 16.0 |
| 415 | 160 | Catalyst 1 | 1.0% | Pre-Mixed | 2.5% | 4.3 | 37.9 | 9.8 | 27.4 | 9.1 | 20.4 |
| 385 | 180 | Catalyst 1 | 0.5% | Separate | 5.0% | 4.3 | 37.8 | 7.3 | 21.8 | 6.6 | 16.0 |
| 375 | 180 | none | na | Separate | 5.0% | 4.8 | 36.3 | 8.6 | 23.0 | 8.0 | 16.3 |
| 375 | 180 | Catalyst 1 | 0.5% | Separate | 5.0% | 4.7 | 34.8 | 7.4 | 25.1 | 6.7 | 15.2 |

Swelling in thickness requirements decrease with increasing grade (EPF), 25% being the requirement for OSB/1, 20% for OSB/2, and for the load bearing humid conditions grades OSB/3 at 15% max and OSB/4 at 12% max. The Comparative catalyst 1 catalyzed formulation barely meets the requirement for OSB/1. As noted the subject catalysis did not appear to impact WA/TS greatly (nor negatively) but did provide slight improvements over non-catalyzed systems, all boards made with Catalyst 1, Catalyst 3, or no catalyst would meet the requirements for OSB/1-2, and a few boards would qualify for OSB/3 (pending further testing). To meet the high-grade standards, it is assumed that higher levels of pMDI would be required, with little benefit provided by the catalyst for WA/TS attributes.

Internal Bond Testing

Internal bond (IB) testing was conducted using ASTM D1037-12 under the panel production conditions described above with respect to Experiments 1-6. The testing evaluated the cohesion of the panel in the direction perpendicular to the panel plane.

Experiment #1: Standard Conditions

Catalyst 1 provides a substantial improvement in IB compared to those evaluated with no catalyst. Catalyst 3 did not improve IB under standard conditions.

TABLE 10
(IB determination via standard conditions)

| | | | | | | Retained | | | |
|---|---|---|---|---|---|---|---|---|---|
| | | | | | | Flexural | | | |
| Platen | Press | | | | | Strength | Internal Bond | | |
| Temp | Cook Time | | Catalyst | Catalyst/MDI | MDI | MM_{D4}/MM_{Dry} | IB | Density | IB |
| (F.) | (sec) | Catalyst | Loading | Introduction | Loading | (%) | (psi) | (pcf) | (N/mm²) |
| 415 | 180 | none | na | Separate | 5.0% | 77.9 | 81.9 | 40.2 | 0.56 |
| 415 | 180 | Catalyst 1 | 0.5% | Separate | 5.0% | 91.5 | 102.9 | 37.0 | 0.71 |
| 415 | 180 | Catalyst 3 | 0.5% | Separate | 5.0% | 95.5 | 73.0 | 37.2 | 0.50 |

Under standard conditions all boards meet the highest-grade standards for Initial IB.

Experiment #2/#6: Decreased Press Time and Catalyst Introduction Study

TABLE 11
(IB determination via decreased press time)

| | | | | | | Retained | | | |
|---|---|---|---|---|---|---|---|---|---|
| | | | | | | Flexural | | | |
| Platen | Press | | | | | Strength | Internal Bond | | |
| Temp | Cook Time | | Catalyst | Catalyst/MDI | MDI | MM_{D4}/MM_{Dry} | IB | Density | IB |
| (F.) | (sec) | Catalyst | Loading | Introduction | Loading | (%) | (psi) | (pcf) | (N/mm²) |
| 415 | 160 | none | na | Separate | 5.0% | 90.7 | 29.9 | 38.9 | 0.21 |
| 415 | 160 | Catalyst 3 | 0.5% | Separate | 5.0% | 106.8 | 32.3 | 38.5 | 0.22 |
| 415 | 160 | Catalyst 1 | 0.5% | Pre-Mixed | 5.0% | 91.5 | 53.2 | 37.9 | 0.37 |
| 415 | 160 | Comparative | 0.5% | Separate | 5.0% | 35.5 | 12.4 | 37.5 | 0.09 |
| | | Catalyst 1 | | | | | | | |
| 415 | 160 | Catalyst 1 | 0.5% | Separate | 5.0% | 89.5 | 44.0 | 36.8 | 0.30 |

Decreased press time negatively impacts IB. Both catalyst 1 and catalyst 3 provide improved IB over no catalyst whereas comparative catalyst 1 does not. IB for catalyst 1 catalyzed resin is ˜50% reduced vs. standard conditions. Shorter press time may be possible whilst maintaining IB levels comparable to no catalysis under standard conditions. In this instance the pre-mix introduction of catalyst appears to improve IB vs. separate addition. Under these conditions catalyst 1 would provide OSB/2-3 grade product (OSB/3 would be determined by IB after cycle test or boil test). Under these specified conditions the use of no catalyst or comparative catalyst 1 would not provide a commercial grade of OSB according to EN 300 (IB fail at all thicknesses). A higher catalyst load or increase in MDI may be required with shorter press times to exceed IB performance under standard conditions.

Experiment #3: Reduction in pMDI Loading

TABLE 12
(IB; determined via decreased pMDIunder standard process conditions)

| | | | | | | Retained | | | |
|---|---|---|---|---|---|---|---|---|---|
| | | | | | | Flexural | | | |
| Platen | Press | | | | | Strength | Internal Bond | | |
| Temp | Cook Time | | Catalyst | Catalyst/MDI | MDI | MM_{D4}/MM_{Dry} | IB | Density | IB |
| (F.) | (sec) | Catalyst | Loading | Introduction | Loading | (%) | (psi) | (pcf) | (N/mm²) |
| 415 | 180 | none | na | Separate | 2.5% | 88.4 | 49.3 | 38.1 | 0.34 |
| 415 | 180 | Catalyst 1 | 0.5% | Separate | 2.5% | 99.7 | 59.3 | 37.1 | 0.41 |
| 415 | 180 | Catalyst 3 | 0.5% | Separate | 2.5% | 98.8 | 54.8 | 36.7 | 0.38 |
| 415 | 180 | Comparative | 0.5% | Separate | 2.5% | 17.6 | 7.8 | 38.4 | 0.05 |
| | | Catalyst 1 | | | | | | | |

Decreased MDI load (2.5% vs. 5%) also negatively impacts IB, with both catalyst 1 and catalyst 3 providing improved values over no catalyst. Comparative catalyst 1 at the same level does not provide positive benefit, negatively impacting IB with decreased pMDI levels. No catalyst or the use of catalyst 3 provides an OSB/2-3 potential product at the greater thickness threshold, whereas catalyst 1 provides a potential OSB/4 (requirement for cycle or boil test). Both subject catalysts (catalyst 1 and catalyst 3) provide marked improvement in retained flexural strength vs. no catalysis and comparative catalyst 1.

Experiment #4/#6: Reduction in Press Time, pMDI Loading, and Catalyst Introduction Study

TABLE 13
(IB determined via; decreased pMDI and press time; stand temp; higher catalyst load)

| | | | | | | Retained | | | |
|---|---|---|---|---|---|---|---|---|---|
| | | | | | | Flexural | | | |
| Platen | Press | | | | | Strength | Internal Bond | | |
| Temp | Cook Time | | Catalyst | Catalyst/MDI | MDI | MM_{D4}/MM_{Dry} | IB | Density | IB |
| (F.) | (sec) | Catalyst | Loading | Introduction | Loading | (%) | (psi) | (pcf) | (N/mm²) |
| 415 | 160 | Catalyst 1 | 1.0% | Separate | 2.5% | 105.4 | 43.6 | 35.6 | 0.30 |
| 415 | 160 | Catalyst 3 | 1.0% | Separate | 2.5% | 113.3 | 32.0 | 35.8 | 0.22 |
| 415 | 160 | Catalyst 1 | 1.0% | Pre-Mixed | 2.5% | 96.5 | 48.4 | 36.4 | 0.33 |

Combining decreased press time with decreased pMDI levels results in poorer IB vs. standard conditions. Premixing again appears to provide some benefit and catalyst 1 provides improved IB over catalyst 3, at 1.0% loading. Reduction in press time only with the use of no catalyst provided IB strength of 29.9 psi, thus the reduction of pMDI loading (with no catalyst 49.3 psi) was anticipated to result in unacceptable boards.

Experiment #5: Reduction in Press Time

TABLE 14
(IB determined at reduced temp)

| | | | | | | Retained | | | |
|---|---|---|---|---|---|---|---|---|---|
| | | | | | | Flexural | | | |
| Platen | Press | | | | | Strength | Internal Bond | | |
| Temp | Cook Time | | Catalyst | Catalyst/MDI | MDI | MM_{D4}/MM_{Dry} | IB | Density | IB |
| (F.) | (sec) | Catalyst | Loading | Introduction | Loading | (%) | (psi) | (pcf) | (N/mm²) |
| 385 | 180 | Catalyst 1 | 0.5% | Separate | 5.0% | 93.3 | 51.9 | 37.9 | 0.36 |
| 375 | 180 | Catalyst 1 | 0.5% | Separate | 5.0% | 105.0 | 24.9 | 37.1 | 0.17 |
| 375 | 180 | none | na | Separate | 5.0% | 84.5 | 15.1 | 37.5 | 0.10 |

Decreased temperature provides the greatest impact on IB in the absence of catalysis, with catalyst 1 performing well at a minimum temperature of 385° F. (˜7% reduction in temperature) at OSB/2-3 grade (cycle and boil up testing required). A temperature of 385° F. or press time of 160 seconds (at 415° F.) both provide acceptable IB performance with the use of catalyst 1.

Internal Bond Strength Testing Summary.

TABLE 15
(IB summary)

| | | | | | | Retained | | | |
|---|---|---|---|---|---|---|---|---|---|
| | | | | | | Flexural | | | |
| Platen | Press | | | | | Strength | Internal Bond | | |
| Temp | Cook Time | | Catalyst | Catalyst/MDI | MDI | MM_{D4}/MM_{Dry} | IB | Density | IB |
| (F.) | (sec) | Catalyst | Loading | Introduction | Loading | (%) | (psi) | (pcf) | (N/mm²) |
| 415 | 180 | none | na | Separate | 5.0% | 77.9 | 81.9 | 40.2 | 0.56 |
| 415 | 180 | Catalyst 1 | 0.5% | Separate | 5.0% | 91.5 | 102.9 | 37.0 | 0.71 |
| 415 | 180 | Catalyst 3 | 0.5% | Separate | 5.0% | 95.5 | 73.0 | 37.2 | 0.50 |
| 415 | 160 | none | na | Separate | 5.0% | 90.7 | 29.9 | 38.9 | 0.21 |
| 415 | 160 | Catalyst 3 | 0.5% | Separate | 5.0% | 106.8 | 32.3 | 38.5 | 0.22 |
| 415 | 160 | Catalyst 1 | 0.5% | Pre-Mixed | 5.0% | 91.5 | 53.2 | 37.9 | 0.37 |
| 415 | 160 | Comparative | 0.5% | Separate | 5.0% | 35.5 | 12.4 | 37.5 | 0.09 |
| | | Catalyst 1 | | | | | | | |
| 415 | 160 | Catalyst 1 | 0.5% | Separate | 5.0% | 89.5 | 44.0 | 36.8 | 0.30 |
| 415 | 180 | none | na | Separate | 2.5% | 88.4 | 49.3 | 38.1 | 0.34 |
| 415 | 180 | Catalyst 1 | 0.5% | Separate | 2.5% | 99.7 | 59.3 | 37.1 | 0.41 |
| 415 | 180 | Catalyst 3 | 0.5% | Separate | 2.5% | 98.8 | 54.8 | 36.7 | 0.38 |
| 415 | 180 | Comparative | 0.5% | Separate | 2.5% | 17.6 | 7.8 | 38.4 | 0.05 |
| | | Catalyst 1 | | | | | | | |
| 415 | 160 | Catalyst 1 | 1.0% | Separate | 2.5% | 105.4 | 43.6 | 35.6 | 0.30 |
| 415 | 160 | Catalyst 3 | 1.0% | Separate | 2.5% | 113.3 | 32.0 | 35.8 | 0.22 |
| 415 | 160 | Catalyst 1 | 1.0% | Pre-Mixed | 2.5% | 96.5 | 48.4 | 36.4 | 0.33 |
| 385 | 180 | Catalyst 1 | 0.5% | Separate | 5.0% | 93.3 | 51.9 | 37.9 | 0.36 |
| 375 | 180 | Catalyst 1 | 0.5% | Separate | 5.0% | 105.0 | 24.9 | 37.1 | 0.17 |
| 375 | 180 | none | na | Separate | 5.0% | 84.5 | 15.1 | 37.5 | 0.10 |

The use of catalyst 1 provides improved IB compared to the trials with no catalyst under all variables providing ˜50 psi minimum for all tests with the exception of decreased press time and reduced MDI levels where catalyst 1 achieved 43-48 psi strength. Catalyst 3 was comparable to the no catalyst comparative example in most cases or slightly improved. Comparative catalyst 1 provided very poor IB under the same conditions at the same use levels.

Flexural Testing: Determination of Modulus of Rupture (MOR) and Apparent Modulus of Elasticity (MOE).

Modulus of rupture and apparent modulus of elasticity were evaluated using ASTM D1037-12 on composites formed under the conditions of Experiments 1-6 described above. MOR is the measure of stress in the material prior to rupture, i.e. stiffness or flexural strength or bend strength. MOE is the measure of the ratio of stress placed on material compared to strain (deformation) that the material exhibits along its length. MOE and MOR data will be utilized from the dry specimens, but comment will be provided on the D-4 cycle specimens. The D-4 cycle is the saturation of the specimen under vacuum followed by drying. The key attribute obtained from this analysis is the Retained Flexural strength that is a ratio of the maximum moment (D4) to that of the MM from Dry testing. MOE and MOR are calculated based on both the pre-cycle and post cycle dimensions, however the data presented and discussed is relevant only to the pre-cycle dimensions; data noted is an average of at least 2 boards (typically three) produced using the same resin blend.

Experiment #1: Standard Conditions

Dry: At comparable density and MC % (moisture content) the catalyzed and uncatalyzed specimens provide similar MOE and MOR values. Failure modes for all specimens were via tension.

D4 cycle: Comparable MOE and MOR within the set Density reduction due to swelling is noticeable. Retained Flexural Strength is improved with the use of the catalyst, which is the key attribute of this analysis, with values >75% being typically required for graded materials. Failure modes for these specimens were all through tension.

TABLE 16
(Flexural Modulus via standard conditions)

| | | | | | | | | | | | | | | Retained |
|---|---|---|---|---|---|---|---|---|---|---|---|---|---|---|
| | | | | | | Flexure (dry) | | | | | | | | Flexural |
| | Press | | | Catalyst/ | | | | | MM | | | | | Strength |
| Platen | Cook | | | MDI | | | EI (lbf- | | (lbf- | | | | | MM_{D4}/ |
| Temp | Time | | Catalyst | Intro- | MDI | MOE | in.²/ft | MOR | in./ft | Density | MC | MOE | MOR | MM_{Dry} |
| (F.) | (sec) | Catalyst | Loading | duction | Loading | (psi) | width) | (psi) | width) | (pcf) | (%) | (N/mm²) | (N/mm²) | (%) |
| 415 | 180 | Catalyst 3 | 0.5% | Separate | 5.0% | 677,811 | 237,239 | 5,202 | 5,177 | 38.1 | 4.1 | 4,673.3 | 35.9 | 95.5 |
| 415 | 180 | Catalyst 1 | 0.5% | Separate | 5.0% | 701,718 | 244,028 | 5,561 | 5,507 | 38.8 | 4.3 | 4,838.2 | 38.3 | 91.5 |
| 415 | 180 | none | na | Separate | 5.0% | 754,816 | 281,691 | 6,171 | 6,375 | 38.6 | 4.6 | 5,204.3 | 42.5 | 77.9 |

Experiment #2/#6: Decreased Press Time and Catalyst Introduction Study

Dry: With decreased press time there was an improvement in MOE and MOR for the catalyst 1 and catalyst 3 catalyzed processes. Comparative catalyst 1 is substantially worse than the subject catalyst catalyzed processes. Premixing catalyst 1 does not appear to influence these properties. Failure mode for the dry specimens resulting from decreased press time were predominantly through tension for subject catalysis panels. Fifty-five percent of non-catalyzed specimens failed through shear, twenty-two percent of catalyst 3 and comparative catalyst 1 specimens failed through shear, whereas all of the catalyst 1 specimens failed through tension alone.

D4 cycle: Catalyst 3 shows improved Retention of Flexural strength over catalyst 1, which is comparable to the uncatalyzed specimen. In general comparative catalyst 1 is poor across this set with respect to MOE and MOR. Non-catalyzed and subject catalyst-catalyzed specimens provide >75% retention. The comparative catalyst 1 catalyzed systems see a dramatic reduction in density, owing to the loss in retained strength. Failure mode via shear increases with D4 cycle specimens; twenty-five percent of catalyst 1 specimens, seventy-eight percent of non-catalyzed specimens, forty-five percent of catalyst 3 specimens, and one hundred percent of comparative catalyst 1 specimens fail through shear. The data presented demonstrates the positive impact of the subject catalysis on general flexural strength of panels produced with shorter press time.

TABLE 17
(Flexural Modulus via decreased press time)

| | | | | | | | | | | | | | | Retained |
|---|---|---|---|---|---|---|---|---|---|---|---|---|---|---|
| | | | | | | Flexure (dry) | | | | | | | | Flexural |
| | Press | | | Catalyst/ | | | | | MM | | | | | Strength |
| Platen | Cook | | | MDI | | | EI (lbf- | | (lbf- | | | | | MM_{D4}/ |
| Temp | Time | | Catalyst | Intro- | MDI | MOE | in.²/ft | MOR | in./ft | Density | MC | MOE | MOR | MM_{Dry} |
| (F.) | (sec) | Catalyst | Loading | duction | Loading | (psi) | width) | (psi) | width) | (pcf) | (%) | (N/mm²) | (N/mm²) | (%) |
| 415 | 160 | Catalyst 1 | 0.5% | Pre-Mixed | 5.0% | 697,838 | 245,946 | 5,201 | 5,204 | 38.1 | 4.3 | 4,811.4 | 35.9 | 91.5 |
| 415 | 160 | Comparative | 0.5% | Separate | 5.0% | 551,944 | 194,033 | 2,600 | 2,589 | 38.4 | 4.3 | 3,805.5 | 17.9 | 35.5 |
| | | Catalyst 1 | | | | | | | | | | | | |
| 415 | 160 | Catalyst 3 | 0.5% | Separate | 5.0% | 677,520 | 242,850 | 4,737 | 4,788 | 37.9 | 4.1 | 4,671.3 | 32.7 | 106.8 |
| 415 | 160 | Catalyst 1 | 0.5% | Separate | 5.0% | 680,013 | 247,089 | 5,454 | 5,499 | 37.1 | 4.6 | 4,688.5 | 37.6 | 89.5 |
| 415 | 160 | none | na | Separate | 5.0% | 602,814 | 201,241 | 3,675 | 3,706 | 37.6 | 4.4 | 4,156.3 | 25.3 | 90.7 |

Experiment #3: Reduction in pMDI Loading

Dry: Under the reduced pMDI levels comparative catalyst 1 performs poorly. The subject catalysis and non-catalyzed systems are nearly equivalent, with slight improvements with the use of catalyst 1. Failure mode for the dry specimens resulting from decreased press time were solely through tension for subject catalysis and non-catalyzed panels. One hundred percent of comparative catalyst 1 specimens failed through shear.

D4 Cycle: Catalyst 3 and Catalyst 1 provided improved retained flexural strength at comparable density. MOE and MOR are comparable using both pre- and post-cycle dimensions. Retained flexural strength appears to be more impacted by press time than MDI level in consideration of the use of the subject catalysts vs. no catalysis (and comparative catalyst 1). The subject catalysis specimens all failed through tension alone with twenty-two percent of non-catalyzed specimens and 89% of comparative catalyst 1 specimens failing through shear.

TABLE 18
(Flexural Modulus via reduction in pMDI loading)

| | | | | | | | | | | | | | | Retained |
|---|---|---|---|---|---|---|---|---|---|---|---|---|---|---|
| | | | | | | Flexure (dry) | | | | | | | | Flexural |
| | Press | | | Catalyst/ | | | | | MM | | | | | Strength |
| Platen | Cook | | | MDI | | | EI (lbf- | | (lbf- | | | | | MM_{D4}/ |
| Temp | Time | | Catalyst | Intro- | MDI | MOE | in.²/ft | MOR | in./ft | Density | MC | MOE | MOR | MM_{Dry} |
| (F.) | (sec) | Catalyst | Loading | duction | Loading | (psi) | width) | (psi) | width) | (pcf) | (%) | (N/mm²) | (N/mm²) | (%) |
| 415 | 180 | Comparative | 0.5% | Separate | 2.5% | 437,546 | 156,507 | 1,138 | 1,143 | 37.9 | 4.7 | 3,016.8 | 7.8 | 17.6 |
| | | Catalyst 1 | | | | | | | | | | | | |
| 415 | 180 | Catalyst 3 | 0.5% | Separate | 2.5% | 725,338 | 246,346 | 5,040 | 4,917 | 38.5 | 4.3 | 5,001.0 | 34.7 | 98.8 |
| 415 | 180 | Catalyst 1 | 0.5% | Separate | 2.5% | 650,458 | 217,435 | 4,719 | 4,550 | 38.0 | 4.6 | 4,484.8 | 32.5 | 99.7 |
| 415 | 180 | none | na | Separate | 2.5% | 663,727 | 230,074 | 4,820 | 4,757 | 38.2 | 4.5 | 4,576.2 | 33.2 | 88.4 |

Experiment #4/#6: Reduction in Press Time, pMDI Loading, and Catalyst Introduction Study.

Dry: Both subject catalysts provide comparable MOE and MOR data, with performance enhancement when catalyst 1 is premixed with isocyanate rather than added separately. Specimens prepared via catalyst 1 failed through tension alone and eleven percent of catalyst 3 specimens failed via shear, the remainder failing through tension.

D4 Cycle: Demonstration of good retention of Flexural strength using the catalysts. No comparison to non-catalyzed or comparative catalyst 1, both of which did not perform as well under the separate conditions. Comparable MOE and MOR was found for both subject catalysts. No failure through shear was observed for either pMDI introduction method for catalyst 1, all failing through tension alone. The catalyst 3 specimens after D4 cycle failed via shear at eleven percent, comparable to pre-cycle results.

TABLE 19
(Flexural Modulus via reduction in press time, pMDI loading and catalyst introduction)

| | | | | | | | | | | | | | | Retained |
|---|---|---|---|---|---|---|---|---|---|---|---|---|---|---|
| | | | | | | Flexure (dry) | | | | | | | | Flexural |
| | Press | | | Catalyst/ | | | | | MM | | | | | Strength |
| Platen | Cook | | | MDI | | | EI (lbf- | | (lbf- | | | | | MM_{D4}/ |
| Temp | Time | | Catalyst | Intro- | MDI | MOE | in.²/ft | MOR | in./ft | Density | MC | MOE | MOR | MM_{Dry} |
| (F.) | (sec) | Catalyst | Loading | duction | Loading | (psi) | width) | (psi) | width) | (pcf) | (%) | (N/mm²) | (N/mm²) | (%) |
| 415 | 160 | Catalyst 1 | 1.0% | Pre-Mixed | 2.5% | 655,116 | 237,271 | 5,217 | 5,308 | 38.3 | 4.4 | 4,516.9 | 36.0 | 96.5 |
| 415 | 160 | Catalyst 3 | 1.0% | Separate | 2.5% | 686,354 | 240,958 | 5,331 | 4,580 | 37.7 | 4.2 | 4,732.2 | 36.8 | 113.3 |
| 415 | 160 | Catalyst 1 | 1.0% | Separate | 2.5% | 588,936 | 221,833 | 3,930 | 4,104 | 37.0 | 4.7 | 4,060.6 | 27.1 | 105.4 |

Experiment #5: Reduction in Press Temperature

Dry: Non-catalyzed boards were not able to be produced at less than 375° F. Catalyzed boards improved in aesthetics with increasing temperature. Boards were acceptable at 375° F., but here we see drastic depression in MOR for the non-catalyzed boards. Slight improvement with the Catalyst 1 at 385° F. vs. 375° F., which is comparable to results obtained at 415° F. Catalyst 1 specimens at both temperatures failed via tension alone with fifty-five percent of non-catalyzed specimens failing via shear.

D4 Cycle: Retained Flexural strength is still acceptable for both non-catalyzed and catalyst 1 catalyzed systems at >75% at reduced temperatures, however a marked improvement for catalyzed vs. non-catalyzed systems is noted Catalyst 1 specimens at 375° F. failed via shear at eleven percent only with specimens produced at 385° F. failing only via tension following the D4 cycle. Seventy eight percent of non-catalyzed specimens failed via shear following the D4 cycle.

TABLE 20
(Flexural Modulus via reduction in press temperature)

| | | | | | | | | | | | | | | Retained |
|---|---|---|---|---|---|---|---|---|---|---|---|---|---|---|
| | | | | | | Flexure (dry) | | | | | | | | Flexural |
| | Press | | | Catalyst/ | | | | | MM | | | | | Strength |
| Platen | Cook | | | MDI | | | EI (lbf- | | (lbf- | | | | | MM_{D4}/ |
| Temp | Time | | Catalyst | Intro- | MDI | MOE | in.²/ft | MOR | in./ft | Density | MC | MOE | MOR | MM_{Dry} |
| (F.) | (sec) | Catalyst | Loading | duction | Loading | (psi) | width) | (psi) | width) | (pcf) | (%) | (N/mm²) | (N/mm²) | (%) |
| 385 | 180 | Catalyst 1 | 0.5% | Separate | 5.0% | 686,354 | 258,045 | 5,331 | 5,562 | 37.7 | 4.2 | 4,732.2 | 36.8 | 93.3 |
| 375 | 180 | Catalyst 1 | 0.5% | Separate | 5.0% | 624,295 | 231,719 | 4,561 | 4,715 | 37.1 | 4.7 | 4,304.4 | 31.4 | 105.0 |
| 375 | 180 | none | na | Separate | 5.0% | 522,664 | 203,878 | 2,802 | 2,978 | 36.6 | 4.9 | 3,603.6 | 19.3 | 84.5 |

The experimental catalysis improves the retention of flexural strength in general, reducing failure through shear vs. non-catalysis and comparative catalysis under extreme processing condition including reduced press time at standard temperature, reduced pMDI levels, and reduced press temperature at standard press time.

The foregoing description identifies various, non-limiting embodiments of a catalyst composition. Modifications may occur to those skilled in the art and to those who may make and use the invention. The disclosed embodiments are merely for illustrative purposes and not intended to limit the scope of the invention or the subject matter set forth in the claims.

1. A catalyst composition comprising (i) a metal elected from a metal complex comprising a metal from Groups IB, IIB, IVB, VB, VIIB, VIIB, and VIIIB of the Periodic Table of the Elements; and (ii) a solvent selected from a dialkyl sulfoxide, an organic carbonate; acetic acid; a carboxylic acid, an N-alkyl amides, organic carboxylic acid diester or diamide or mixed ester-amide, or a combinations of two or more thereof.

2. The catalyst composition of claim 1, wherein the metal is selected from Cu(II), Ni(II), Fe(II), Fe(III), Fe(IV), Zn, Zr, Mn, Cr, Ti, V, Mo, Ru, Rh, Bi, Sn, or a combination of two or more thereof.

3. The catalyst composition of claim 2, where in the metal complex comprises a ligand or counter ion chosen from a carboxylate, a diketonate, a salicylate, an organic salt, a halide, or a combination of two or more thereof.

4. The catalyst composition of claim 1, wherein the metal is cupric acetylacetonate.

5. The catalyst composition of claim 1, wherein the metal is cupric acetate.

6. The catalyst composition of claim 1, wherein the metal is cupric salicylate.

7. The catalyst composition of claim 1, wherein the dialkyl sulfoxide is chosen from dimethyl sulfoxide, diethyl sulfoxide, diisobutyl sulfoxide, or a combination of two more thereof, the organic carbonate is chosen from di-methyl-carbonate, ethylene-carbonate, propylene-carbonate, or a combination of two or more thereof, the carboxylic acid is chosen from one or more aliphatic carboxylic acids having 2-50 carbon atoms; the N-alkyl amide is chosen from N-methyl pyrrolidone (NMP), N-n-butylpyrrolidone, N-isobutylpyrrolidone, N-t-butylpyrrolidone, N-n-pentylpyrrolidone, N-(methyl-substituted butyl) pyrrolidone, ring-methyl-substituted N-propyl pyrrolidone, ring-methyl-substituted N-butyl pyrrolidone, N-(methoxypropyl) pyrrolidone, N-(methoxypropyl) pyrrolidone, 1,5-dimethyl-pyrrolidone, and isomers thereof, or combinations of two or more thereof.

8. The catalyst composition of claim 1, wherein the metal component is present in an amount of from about 0.04 wt. % to about 10 wt. %; and the solvent is present in an amount of from about 90 wt. % to about 99.96 wt. %

9. The catalyst composition of claim 1, wherein the metal complex comprises copper, and the solvent is dimethylsulfoxide.

10. The catalyst composition of claim 1, wherein the solvent is a mixture of a dialkyl sulfoxide and a N-alkyl amide.

11. The catalyst composition of claim 10, wherein the dialkyl sulfoxide is present in an amount of from about 60 wt. % to about 90 wt. % based on the total weight of the solvent; and the N-alkyl amide may be present in an amount of from about 10 wt. % to about 40 wt. % based on the total amount of the solvent.

12. The catalyst composition of claim 10, wherein the dialkyl sulfoxide is chosen from dimethyl sulfoxide, and the N-alkyl amide is N-methyl pyrrolidone.

13. The catalyst composition of claim 1, wherein the solvent comprises an organic carbonate and acetic acid and/or a carboxylic acid.

14. The catalyst composition of claim 13, wherein the organic carbonate is present in an amount of from about 10 wt. % to about 90 wt. % based on the total weight of the solvent; and the acetic acid or carboxylic acid may be present in an amount of from about 10 wt. % to about 50 wt. % based on the total amount of the solvent.

15. The catalyst composition of claim 12, wherein the solvent is a mixture of propylene carbonate and acetic acid.

16. The catalyst composition of claim 1, wherein the solvent comprises an organic carbonate an amino alcohol, and/or a carboxylic acid.

17. The catalyst composition of claim 16, wherein the organic carbonate is present in an amount of from about 50 wt. % to about 99 wt. % based on the total weight of the solvent; and the acetic acid or carboxylic acid may be present in an amount of from about 0.5 wt. % to about 50 wt. % based on the total amount of the solvent; and the amino alcohol is present in an amount of about 0.5 wt % to about 50 wt % based on the total amount of the solvent.

18. The catalyst composition of claim 1, wherein the solvent is a mixture of propylene carbonate an amine and a carboxylic acid.

19. A binder composition comprising (a) an isocyanate, and (b) a catalyst composition of claim 1.

20. The binder composition of claim 19, wherein the binder comprises from about 60 to 99.9 wt. % of the isocyanate compound and from about 0.1 to about 40 wt, % of the catalyst composition based on the total weight of the binder composition.

21. A binder composition for forming a cellulosic composite, the composition comprising (a) an isocyanate compound, (b) a catalyst composition of claim 1, and (c) a cellulosic material.

22. A composition for forming a cellulosic composite, the composition comprising (a) a binder composition of claim 19, and (b) a cellulosic material.

23. A method for producing a cellulosic composite comprising forming a mixture of a cellulosic material, a catalyst, and an isocyanate and subjecting the mixture to heat and pressure to form a composite, wherein (i) the catalyst is chosen from a catalyst composition comprising (a) a metal elected from a metal complex comprising a metal from Groups IB, IIB, IVB, VB, VIIB, VIIB, and VIIIB of the Periodic Table of the Elements; and (b) a solvent selected from a dialkyl sulfoxide an organic carbonate: acetic acid: a carboxylic acid an N-alkyl amides organic carboxylic acid diester or diamide or mixed ester-amide, or a combinations of two or more thereof, and the catalyst and isocyanate are provide separately, or (ii) the catalyst and isocyanate are provided from a binder composition comprising (a) an isoeyanate, and (b) a catalyst composition comprising (a) a metal elected from a metal complex comprising a metal from Groups IB, IIB, IVB, VB, VIIB, VIIB, and VIIIB of the Periodic Table of the Elements; and (b) a solvent selected from a dialkyl sulfoxide, an organic carbonate: acetic acid; a carboxylic acid, an N-alkyl amides, organic carboxylic acid diester or diamide or mixed ester-amide, or a combinations of two or more thereof.
